(19) United States
(12) Patent Application Publication
(10) Pub. No.: US 2018/0117525 A1
(43) Pub. Date: May 3, 2018

(54) IMPROVEMENTS IN OR RELATING TO CARBON CAPTURE

(71) Applicant: Fluid Technologies (Environmental) Limited, Kingston Upon Thames (GB)

(72) Inventors: Howard Paul Davis, Richmond (GB); David William Missions, Ashford (GB)

(21) Appl. No.: 15/560,869

(22) PCT Filed: Mar. 22, 2016
(86) PCT No.: PCT/GB2016/000057

§ 371 Date: Sep. 22, 2017

(30) Foreign Application Priority Data
Apr. 2, 2015 (GB) 1505737.5

(51) Int. Cl. B01D 53/14; B01D 53/62; B01D 53/78; B01J 8/24; B01J 20/28; F23J 15/04

(52) U.S. Cl. CPC B01D 53/1475; B01D 53/62; B01D 53/78; B01J 8/24; B01J 2220/56; F23J 15/04; B01D 2257/504; B01D 2251/304; B01J 20/28

(57) ABSTRACT

In one proposed application provided by the present invention, and as shown in FIG. 2, CO₂ is captured from a dirty flue gas in a fluid bed Turboscrubber® to be recycled rapidly to a fluid bed Turbostripper® where it is desorbed into a clean air stream for introduction to a horticultural glass-house for enhancement of fruit, vegetable or other crop growth. In a further application of the present invention as shown in FIG. 3, CO₂ enriched saltwater is circulated through a tank (7), to feed Algae thereby allowing fast photosynthesis to occur in, for example, the production of bio fuels. Alternatively, if the Algae suspension is sufficiently robust, it can be pumped around a Turboscrubber® (2) and the Algae tank (7) in order to keep it in constant contact with the CO₂ enriched aqueous solution.

The present invention provides a method for capturing Carbon Dioxide (CO₂) from flue gas & waste gas streams in to liquid at a high efficiency (or at a required efficiency) without the need for liquid or aqueous reagents such as Amines and Carbonates.

Currently in order to fulfil the requirement for higher efficiency carbon capture, thus enabling useful transfer to products or storage in a more manageable form, chemical reactions which enhance liquid absorption of CO₂ by reacting with it within the liquid interface are widely employed.

Once captured the CO₂ may have to be released into a more concentrated stream such that it becomes necessary to reverse the chemical reaction which binds it (e.g. K₂CO_{3(aq)}+CO_{2(aq)}+H₂O₍₁₎=2KHCO_{3(aq)}). This is another costly step, which is facilitated by changes in pressure, temperature or chemical equilibrium or by applying a second reagent to ‘unlock’ the CO₂ and release it in a more usable state.

Typically CO₂ recovered in carbon capture plants can be used for Enhanced Oil Recovery or for Growth Enhancement of horticultural crops, fruits & flowers in glass-houses.

By combining the unique properties of counter-current fluidised bed gas scrubbers, which employ fluidisable elements, being hollow or low density solid elements, usually manufactured in plastic materials, with the use of non-reacting salt or saline solutions, a more advantageous result is achieved.

The result is a surprisingly efficient method for capturing carbon and quickly releasing it (from a fluidised bed or other desorber or stripper), which overcomes the need for expensive consumable reagents or application of heat, pressure and additives for CO₂ release and reagent regeneration purposes.

The unique properties of fluid bed gas scrubbers that allow the combinatory effects to function are;
a) Impossible to cause ‘Flooding’;
b) The use of high liquid to gas (L/G) ratios without excessive gas pressure loss;
c) Generation of high interfacial areas particularly with eccentric shapes; and,
d) Salting out (precipitation of salts above the solubility limit) will not block the fluidised bed, which can handle high percentage slurries, or hinder the process

By applying these advantages in combination with the use of salt solutions in water it becomes possible to raise capture efficiencies (CO₂ removal percentage) to well above 50%, which is otherwise not achievable except by employing costly and inherently complicated reacting systems.

Typically salt or saline solutions can include any dissolvable salt up to, and even beyond, its solubility limit such that the solution is maintained at saturation. The important thing is to use an existing saline solution such as brackish or sea water or to increase the salt concentration of a town or process water such that the Ionic Strength of the solution has at least a value of 0.2 mol/litre.

In addition to the requirement for elevated salt concentration, other simultaneous conditions are needed to create the required high removal efficiencies (typically greater than 10% absorption is needed for most applications using CO₂) are to have CO_{2(g)} partial pressures in gas above 1% v/v and L/G ratios, litres/m3, in excess of 20.

At L/G ratios at this level packed towers and sieve plate or tray columns would flood and spray towers would give insufficient interphase surface between the ascending gas and the descending liquid within the scrubber body.

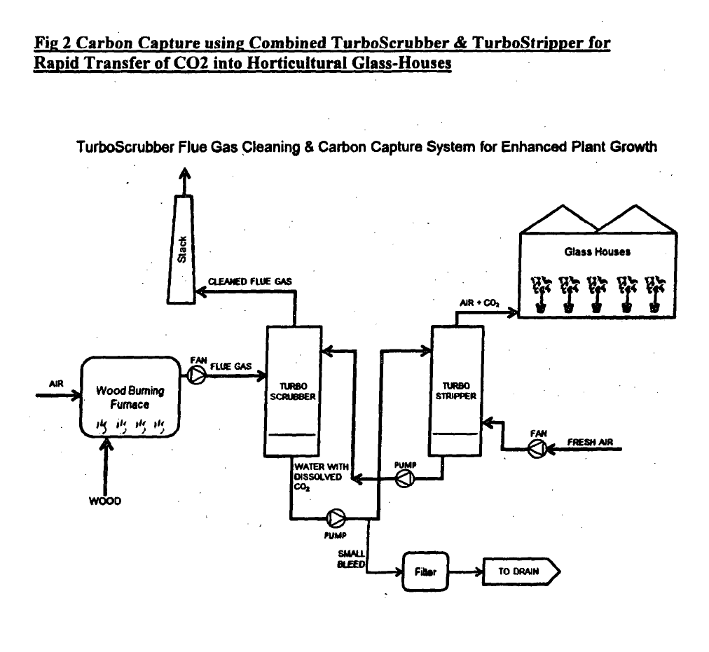

Soluble salts that can be used to boost the Ionic Strength of the resultant saline solution include Chlorides, Bromides, Iodides, Chlorates, Sulphates, Sulphides, Sulfites, Bicarbonates & Phosphates and even Hydroxides & Carbonates which react with CO_{2(aq)}. However, when using rapid desorption (stripping), as in the arrangement FIG. 2, following absorption the CO_{2(aq)}, reactions with these latter two compound groups will be too slow to take effect before the Carbon Dioxide is removed, as required, from the process such that the physical properties of the salts, in helping to effect fast capture of the CO_{2(g)}, are not interfered with by the reactive properties, which would otherwise convert the useful CO₂ to Bicarbonates and Carbonates

A few examples of appropriate salts are CaCl₂, NaCl, KCl, K₂CO₃, KHCO₃, Na₂CO₃, NaHCO₃, CaCO₃, Ca(HCO₃)₂.

Thus, the present invention provides an improved process for carbon capture in accordance with the Claims appended hereto.

There now follows a detailed description of the invention, which is to be read with reference to the accompanying drawings in which:

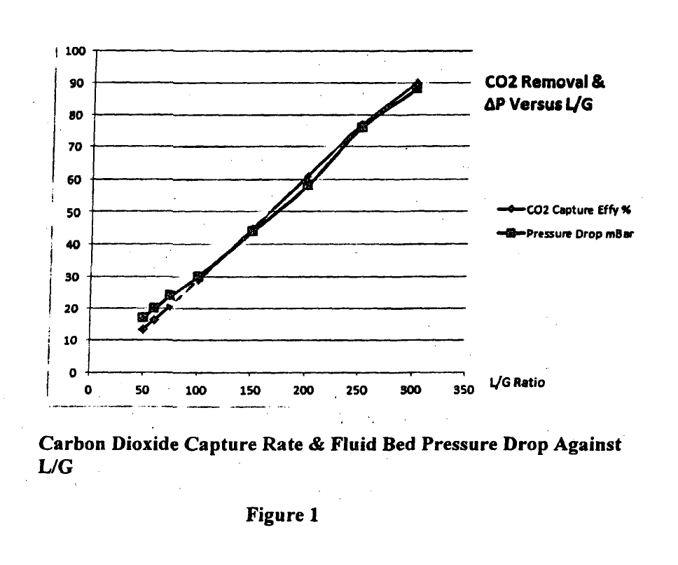

FIG. 1 illustrates a graph of carbon dioxide capture rate and fluid bed pressure drop against L/G;

FIG. 2 is illustrative of a flue gas cleaning plant; and,

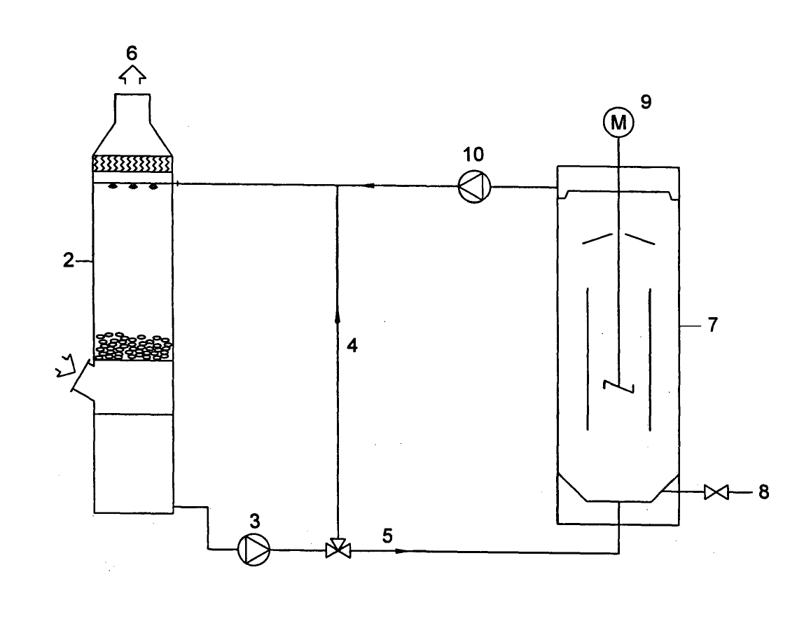

FIG. 3 is illustrative of a carbon dioxide capture and algae tank for photosynthesis.

FIG. 1 shows the relationship between both CO2 removal efficiency & pressure loss through the fluid bed versus L/G ratio for a bed of selected hollow, generally acorn shaped but distended elements made in polypropylene known as TurboPak® in a test tower of 200 mm diameter and with a superficial gas velocity of 0.9 m/s.

The CO₂ was captured in to a semi saturated aqueous solution of Calcium Chloride of about 50% of its pure CaCl_{2(aq)} solubility limit in water at 12° C., (i.e. at about 31.5 g of CaCl_{2(c)} per 100 g of water or 2.84 mol/litre) being the average temperature of the tested saline solution through the scrubber tower, the saline solution having an Ionic Strength of about 8.5 mol/litre.

Other fluidised bed elements are able to generate higher interfacial areas and, hence, greater capture efficiencies and lower pressure drops.

One proposed application of the process is shown in FIG. 2, whereby the CO₂ is captured from a dirty flue gas in a fluid bed scrubber (TurboScrubber®) then cycled rapidly to a fluid bed stripper (TurboStripper®) where it is desorbed in to a clean air stream for introduction to a horticultural glass-house to enhance fruit, vegetable or other crop growth.

Another proposed application of the novel process provided by the present invention is illustrated in FIG. 3, in which process, either CO₂ enriched salt water is circulated through a tank 7 containing Algae to feed the Algae, to allow fast photosynthesis to occur in, for example, the production of bio-fuels, or the Algae suspension, if sufficiently robust, can be pumped around the Turboscrubber® 2 and the Algae tank 7 to keep it in constant contact with the CO₂ enriched aqueous solution.

The Turboscrubber® is provided with:
a) an inlet 1 for the introduction of flue gas;
b) an outlet 6 for gas of reduced CO₂ content; and,
c) a outlet line 5 including a pump 3 for feeding the treated flue gas to the Algae tank 7.

The Algae tank 7 comprises an optional stirrer 9, a bleed valve 8 and on outlet line with a return pump 10 in a line 10a for recirculating treated flue gas to the Turboscrubber® 2.

An optional Algae recycling line 4 is provided between the line 5 and the recirculating line 10a, see FIG. 3.

Modifications may be made to the above described development within the scope of the Claims appended hereto.

1. A process for absorption of carbon dioxide gas in fluidised bed scrubbers, which enhances capture without chemical reaction by a combination of high liquid to gas ratios, being at least 20 litres/m³ and simultaneous use of saline solutions with an Ionic Strength of 0.2 or greater.

2. A process according to claim 1, characterised in that the fluidised bed employs hollow or low density solid plastic, foam or resin manufactured elements of any form, shape or size to ensure good contact and high interfacial area between counter current gas and liquid phases to minimise gaseous flow pressure drop and to avoid “flooding”.

3. A process according to claim 1, characterised in that the concentration of the carbon dioxide in the gas phase is preferably in excess of 1% by volume.

4. A process according to claim 1, characterised in that the carbon dioxide, once captured, is quickly, i.e. within a few minutes, removed from the liquid phase after absorptive capture into solution by cycling the liquid to a fluidised bed or other stripping device to enable desorption to take place.

5. A process according to claim 1, characterised in that the preferred solvent is water or any other suitable liquids.
